(19) United States
(12) Patent Application Publication
(10) Pub. No.: US 2007/0209160 A1
(43) Pub. Date: Sep. 13, 2007

(54) Joint arrangement

(75) Inventors: Karl-Heinz Darscheid, Hillscheid (DE); Rolf Mintgen, Thur (DE); Alexandra Kaiser, Koblenz (DE); Torsten Rickenberg, Neuwied (DE)

Correspondence Address: COHEN, PONTANI, LIEBERMAN & PAVANE, 551 FIFTH AVENUE, SUITE 1210, NEW YORK, NY, 10176, US

(73) Assignee: Stabilus GmbH, Koblenz (DE)

(21) Appl. No.: 11/717,320

(22) Filed: Mar. 13, 2007

(30) Foreign Application Priority Data
Mar. 13, 2006 (DE) 10 2006 011 455

(51) Int. Cl. E05D 11/10

(52) U.S. Cl. 16/334

(57) ABSTRACT

A multi-joint hinge for a motor vehicle having a body and a panel, the hinge allowing the panel to be moved between an open position and a closed position relative to the vehicle body. The hinge includes at joint having at least one roller bearing, and is preferably a four bar joint having two bearings mounted on the body and two bearings mounted on the panel.

### BACKGROUND OF THE INVENTION

1. Field of the Invention

The invention pertains to a joint arrangement, especially a multi-joint hinge, designed to allow a panel of a vehicle to be moved between a closed position and an open position. Joint arrangements are used in particular for the opening and closing of panels of vehicles such as hoods, doors, rear hatches, and/or trunk lids. Such joint arrangements can have at least one rotary joint, which is assigned to the vehicle and to the corresponding panel to be moved, where the panel is supported with freedom to pivot with respect to the vehicle.

2. Description of the Related Art

U.S. Pat. No. 6,669,370, for example, describes a plain bearing with a hinge housing part and a bearing pin, which is inserted into a pressed-in flange bearing bush.

### SUMMARY OF THE INVENTION

An object of the invention is to provide an improved joint arrangement designed to allow a panel of a vehicle to be moved.

In correspondence with the exemplary embodiments of the invention, a joint arrangement, especially a multi-joint hinge, allows a panel of a vehicle to be moved between a closed position and an open position. The joint arrangement or multi-joint hinge has a joint assigned to the vehicle and to the panel. It is advantageous for the joint to have a roller bearing. It is advantageous that the roller bearing minimizes the friction which occurs in the joint even when strong forces are being exerted on the bearing. A joint arrangement of this type can be used to particular advantage for a panel connected to a source of energy, where the source of energy is connected to the vehicle and to the panel in such a way that it minimizes the actuating forces in at least one direction of movement of the panel. Because of the geometries frequently used for panels and the joint arrangements connected to them, the forces acting on the bearings can be very high. When the bearing forces are high, it is possible in particular for undesirably high friction values and/or noise to occur. This is the case especially when conventional joints, especially plain bearings, are used, but excessive friction and noise can be avoided effectively by the use of a roller bearing. A joint arrangement equipped with a roller bearing therefore makes it possible for the panel in question to be opened and closed very easily. Because of the reduced friction values, a high degree of operational reliability is obtained. In addition, the roller bearing can also absorb some of the lever forces acting at a certain angle to the pivot axis without the occurrence of excessive friction values in the bearing. Because of the low friction values, furthermore, the power rating of the source of energy can be made correspondingly lower, as a result of which the overall joint arrangement can be designed with less strength and therefore with a lower weight. The roller bearing of the joint arrangement can also absorb bearing forces which, for example, can be caused by panel misalignment and the manufacturing tolerances of the vehicle body, which can lead to a slightly skewed installation of the joint of the joint arrangement. The roller bearing of the joint arrangement thus makes it possible overall for the panel of the vehicle to which it is attached to be opened and closed more easily and more conveniently.

In an advantageous exemplary embodiment, the roller bearing has rolling elements. These rolling elements can be designed in the form of balls, cylindrical rollers, needles, conical rollers, or barrels. Rollers with elevations at the ends can also be provided. As a result, the friction which occurs against a lateral enclosure of the rollers of the roller bearing can be advantageously minimized. Especially advantageous are rolling elements which are designed as rollers with tips at the ends, as convex rollers, and/or as rollers with tapered ends.

In another advantageous exemplary embodiment, the roller bearing can have bearing rings, such as an inner and an outer bearing ring. The bearing rings are designed to guide the rolling elements on a radius, where the inner ring and the outer bearing ring are able to turn with respect to each other by way of the rolling elements.

In another advantageous exemplary embodiment, the joint arrangement has a hinge pin. The hinge pin can be assigned to the roller bearing, and therefore, for example, be pivotably connected to the outer bearing ring. It is also possible to connect a first lever pivotably to a second lever by way of the roller bearing. Each of these levers can have a bore. One of the levers can be advantageously assigned to the hinge pin, where preferably the hinge pin is introduced by a press-fit into the bore of the corresponding lever. The outer bearing ring of the roller bearing can also be introduced by a press-fit into one of the bores of the lever. To transmit bearing forces from the hinge pin to the associated level, it is possible for the inner bearing ring to form a press-fit with the hinge pin.

In another advantageous exemplary embodiment, the roller bearing has only an outer bearing ring. The rolling elements can therefore be guided inside the outer bearing ring. Advantageously, the hinge pin can take over directly the function of the inner bearing ring of the roller bearing. Therefore, the inner bearing ring can be eliminated. It is advantageous to fabricate the associated hinge pin with sufficiently high surface quality and hardness.

In another advantageous exemplary embodiment, no bearing rings at all are used. In this case, the rolling elements can be guided between one of the bores in the lever and the hinge pin. For this purpose, it is also advantageous to produce the bore of the corresponding lever with sufficiently high precision, that is, with sufficiently high surface quality and hardness. Very few components are required in an embodiment of this type.

In another advantageous exemplary embodiment, one of the levers is riveted to the hinge pin. No other component is therefore required to fasten the lever to the hinge pin, as a result of which the number of parts of the joint arrangement can be further reduced.

In an even more advantageous exemplary embodiment, the joint arrangement has a four-bar joint. By means of the four-bar joint, the panel acquires advantageous kinematics relative to the vehicle which depart from those of a pure pivoting movement. Advantageously, at least one of the joints of the four-bar joint, preferably all four joints of the four-bar joint, can each have its own roller bearing. The four-bar joint can have a total of four levers, where a first lever is assigned permanently to the panel and a second lever to the vehicle. Two additional levers, by way of which the desired movement of the panel occurs, are assigned by way of roller bearings to these first two levers.

In another preferred exemplary embodiment, the joint arrangement is connected to a source of energy. The source of energy can be connected to the vehicle and to the panel by joints. It is also conceivable, however, that the forces could be transmitted from the vehicle to one of the levers of the four-bar joint of the joint arrangement. It is also conceivable that the forces of the source of energy could be transmitted directly between the levers of the joint arrangement. The source of energy can advantageously have a gas spring. The gas spring can store energy which is generated when the panel is opened or closed, so that this energy can be released again during the movement of the panel in the opposite direction. By helping to overcome the force of gravity, the gas spring can make it easier to open the hood, the trunk lid, and/or the rear hatch. Additional functions can also be fulfilled by the source of energy, especially a gas spring, such as a damping function or an arresting function. Because of the highly precise support provided by the roller bearings of the joint arrangement, the forces of the source of energy can be introduced more precisely and with less loss through friction and can therefore be applied with greater efficiency to assist the opening and/or closing of the panel of the vehicle.

Additional exemplary embodiments of the invention pertain to an assembly for a joint arrangement and to a motor vehicle with an assembly of this type. The assembly has a bearing pin and a roller bearing. The roller bearing has rolling elements, which are guided between an outer bearing ring and the bearing pin. An assembly of this type offers the advantage that it can be easily prefabricated by mounting the rolling elements, for example, on the bearing pin. For this purpose, the rolling elements can also be guided by a cage. Then the bearing ring can be set in place also, so that an assembly is obtained which holds itself together. It is advantageous here that the guide elements of the roller bearing (the bearing consisting here of the bearing pin and the outer bearing ring) which are critical with respect to tolerances already present in the assembly. The inner radius of the bearing ring and the outside surface of the bearing pin should also have an appropriately high degree of surface quality, roundness, tolerance, and hardness. For the rest of the installation process, such as the mounting of the assembly on a lever of the joint arrangement, the outer bearing ring can then be simply pressed into a bore in the lever. It is advantageous that the bore of the associated lever can be produced easily, that is, with comparatively low tolerances. In addition, the inside surface of the bore into which the outer bearing ring of the assembly is pressed can be designed to be relatively soft.

Other objects and features of the present invention will become apparent from the following detailed description considered in conjunction with the accompanying drawings. The drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

Similar parts which perform essentially the same function and identical parts are designated by the same reference numbers.

### BRIEF DESCRIPTION OF THE DRAWINGS

FIG. 1 shows a vehicle with a panel and a joint arrangement assigned to the panel and to the vehicle;

FIG. 2 shows a longitudinal cross section through the pivot axis of a joint of a joint arrangement with a ball bearing;

FIG. 3a shows a longitudinal cross section through the pivot axis of a joint similar to the diagram in FIG. 2 but with a roller bearing with an outer bearing ring;

FIGS. 3b-3e each show side views of different designs of rollers for the roller bearing shown in FIG. 3a;

FIG. 4 shows a longitudinal cross section through the pivot axis of a joint similar to the joint shown in FIG. 3a but without bearing rings;

FIG. 5 shows a longitudinal cross section through the pivot axis of a joint with a roller bearing without bearing rings, where a lever assigned to the joint is riveted to a bearing pin of the joint; and

FIG. 6 shows a longitudinal cross section through the pivot axis of an assembly for a joint arrangement, where the assembly has a roller bearing premounted on a bearing pin.

### DETAILED DESCRIPTION OF THE PRESENTLY PREFERRED EMBODIMENTS

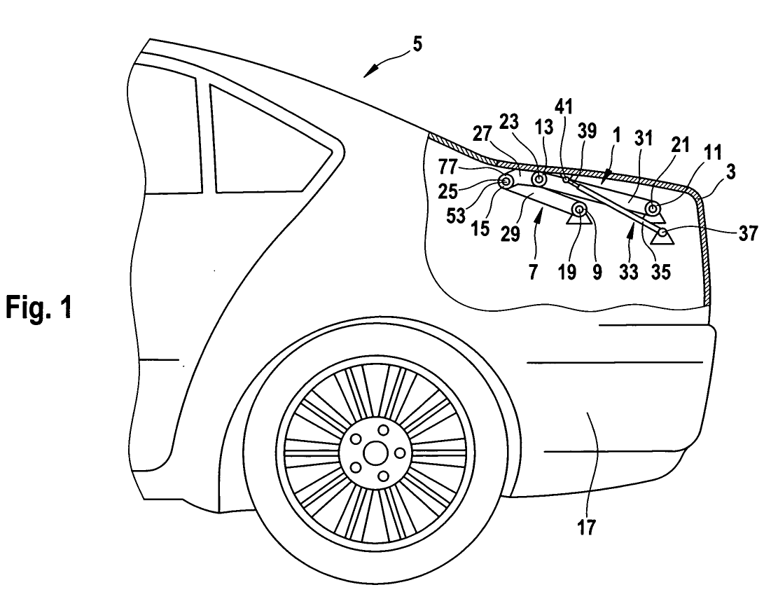

FIG. 1 shows a joint arrangement, especially a multi-joint hinge 1, for a panel 3 of a vehicle 5. The panel 3 here is the trunk lid of a passenger car. The joint arrangement 1 is designed to allow the panel 3 of the vehicle 5 to be moved between a closed position and an open position. FIG. 1 shows the panel 3 in its closed position. The joint arrangement 1 of the vehicle 5 has a four-bar joint 7 with a first joint 9, a second joint 11, a third joint 13, and a fourth joint 15. The first and the second joints 9, 11 are permanently fastened to the body 17 of the vehicle 5. For this mounting, the first joint 9 has a first roller bearing 19, and the second joint 11 has a second roller bearing 21. The third joint 13 and the fourth joint 15 are permanently fastened to the panel 3 of the vehicle 5 and have for this purpose a third roller bearing 23 and a fourth roller bearing 25. The mounting of the third roller bearing 23 and of the fourth roller bearing 25 to the panel 3 is accomplished by way of a first lever 27. The first lever 27 of the four-bar joint 7 is permanently connected to the panel 3 by means of screws or rivets, for example, or by means of welding, adhesive bonding, and/or some similar technique for connecting and/or joining. The first lever 27 of the four-bar joint 7 is pivotably connected via the fourth joint 15 to a second lever 29. A third lever 31 of the four-bar joint 7, furthermore, is pivotably connected to the first lever 27 by way of the third joint 13.

The kinematics of the four-bar joint 7 are designed in such a way that a pivoting of the second lever 29 and of the third lever 31 in the clockwise direction as seen in FIG. 1 results in a steep lifting of the panel 3 in the counterclockwise direction. For this purpose, the third lever 31 can be made longer than the second lever 29. The second lever 29 and the third lever 31 are pivotably supported with respect to the body 17 of the vehicle 5 on the first joint 9 and on the second joint 11. The joint arrangement 1 can have a source of energy 33 to provide an assisting force to help overcome, either partially or completely, the force of gravity which opposes the opening of the panel 3 of the vehicle 5. The source of energy 33 is preferably a spring element, such as a gas spring 35. The gas spring 35 of the joint arrangement 1 is pivotably assigned by way of a bearing 37 to the body 17 of the vehicle 5. A plunger 39 of the gas spring 35 is free to travel outward and is connected pivotably by way of a bearing 41 to the panel 3 of the vehicle 5. Each of the bearings 37 and/or 41 can also have its own roller bearing. The positioning of the bearings 37 and 411 is selected in such a way that the joint arrangement 1 is spring-loaded in a direction such that the elastic force of the gas spring 35 assists the opening movement of the panel 3. It is also conceivable, however, that the bearings 37 and 41 of the gas spring 35 could be positioned so that, when the panel is closed, they are in an over-center position, which would mean that, when the panel 3 is closed, the joint arrangement 1 is spring-loaded in a direction such that the elastic force of the gas spring 35 acts in the closing direction. This can be desirable, when, for example, the goal is to prevent the panel 3 from opening unintentionally.

It is also conceivable that the gas spring 35 could be connected not to the panel 35 but rather to one of the levers, such as to the third lever 31 of the joint arrangement 1. So that the desired flow of forces is also obtained in this case, the bearing 37 of the gas spring 35 can be positioned at a different, appropriate point on the body 17 of the vehicle 5.

Finally, it is conceivable that, instead of the gas spring 35, i.e., the source of energy 33, some other type of linear drive such as a pneumatic or hydraulic linear drive could be provided. It is also conceivable that, instead of the source of energy 33, a rotary drive such as an electric motor could be provided, which acts on one of the levers 27-31.

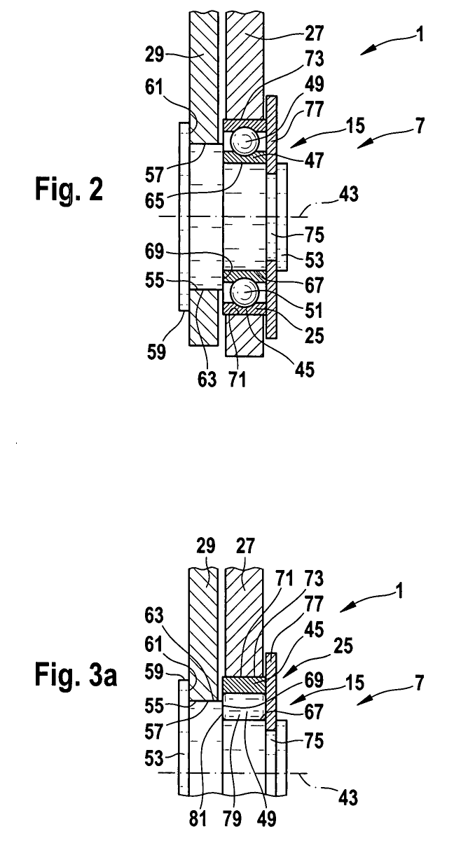

FIG. 2 shows a longitudinal cross section through a pivot axis 43 of one of the joints 9-15 of the joint arrangement 1, i.e., the fourth joint 15 by way of example. The fourth joint 15 of the joint arrangement 1 has the fourth roller bearing 25. The fourth roller bearing 25 has an outer bearing ring 45 and an inner bearing ring 47. The bearing rings 45 and 47 of the fourth roller bearing 25 serve to guide the rolling elements 49 of the fourth roller bearing 25. In the exemplary embodiment according to FIG. 2, the rolling elements 49 of the fourth roller bearing 25 are designed as balls 51. The fourth roller bearing 25 is therefore a ball bearing, and because the bearing rings 45 and 47 are supported against each other by way of the balls 51, they can turn with respect to each other with reduced friction. It is also advantageous for the fourth roller bearing 25 to have in addition a cage (not shown in FIG. 2) to help guide the balls 51.

The fourth roller bearing 25 connects the first lever 27 in articulated fashion to the second lever 29. For this purpose, the fourth joint 15 of the joint arrangement 1 has in addition a bearing pin 53, which is permanently mounted to the second lever 29. The mounting of the second lever 29 to the bearing pin 53 is accomplished by way of the bore 55 in the second lever 29. For this purpose, the bearing pin 53 is pressed into the bore 55 in the second lever 29, so that a press-fit 57 is obtained between the bearing pin 53 and the bore 55 of the second lever 29. Instead of the press-fit 57, however, it would also be possible to use any other suitable joining technique such as welding, screwing, adhesive bonding, and/or similar joining and connecting techniques. To facilitate assembly, that is, to produce the press-fit 57, the bearing pin 53 is designed with steps, where a first step 59, which has the largest diameter, forms a stop 61 for the second lever 29. The second lever 29 can therefore be pressed onto the bearing pin 53 until it comes to rests against the stop 61 of the first step 59 of the bearing pin 53. A second step 63 with a smaller diameter forms the press-fit 57. The outer diameter of the second step 63 is therefore slightly larger than the inner diameter of the bore 55 of the second lever 29.

The inner bearing ring 47 of the fourth roller bearing 25 is also permanently assigned to the bearing pin 53 by means of, for example, a press-fit 65. For this purpose, the bearing pin 53 has a third step 67. The outside diameter of the third step 67 of the bearing pin 53 is slightly larger, for the sake of the press-fit, than the inside diameter of the inner bearing ring 47 of the fourth roller bearing 25. During the production of the press-fit 65, the inner bearing ring 47 can come to rest against a stop 69 on the bearing pin 53.

To connect the fourth roller bearing 25 to the first lever 27, the outer bearing ring 45 of the fourth roller bearing 25 can be pressed into a bore 71 in the first lever 27 in such a way that a press-fit 73 is obtained between the first lever 27 and the outer bearing ring 45.

To secure the fourth roller bearing 25, the third step 67 of the bearing pin 53 can have a circumferential groove 75. A locking ring 77 can engage in the groove 75. The locking ring 77 can be designed as, for example, a snap ring. It is also conceivable, however, that the locking ring 77 could be riveted to the bearing pin 53. Any other method of securing parts together, such as by means of rivets, could also be used.

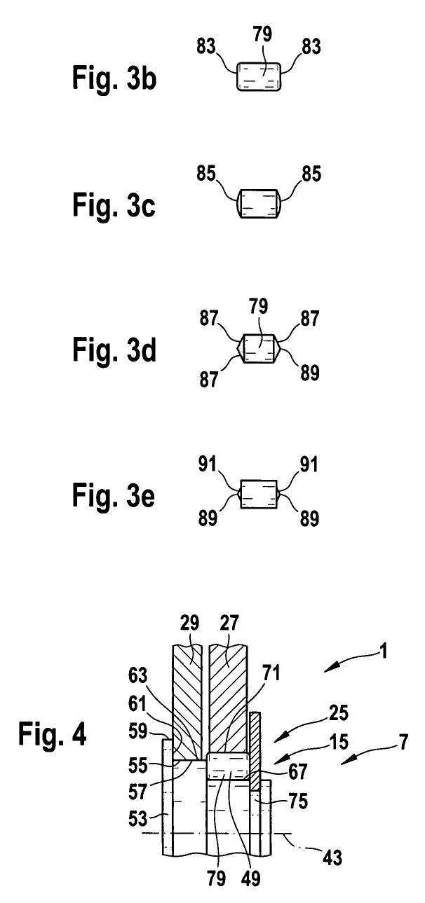

FIG. 3a shows a longitudinal cross section through another space-saving exemplary embodiment of the fourth roller bearing 25, also in a longitudinal cross sectional view through the pivot axis 43. FIG. 3a shows only the upper half of the longitudinal cross section. In contrast to FIG. 2, the fourth roller bearing 25 according to FIG. 3a has only an outer bearing ring 45. Another difference is that rollers 79 are provided as the rolling elements 49 instead of balls. Accordingly, the outer bearing ring 45 can be designed to fit the external form of the rollers 79. The fourth roller bearing 25 according to FIG. 3a is therefore designed as a cylindrical roller bearing. The conventional advantages of cylindrical roller bearings are thus obtained, especially those pertaining to the bearing forces which can be absorbed.

For the lateral guidance of the rollers 79 of the fourth roller bearing 25, the rollers can rest against the locking ring 77 and against the stop 69, which is formed by a shoulder 81 as a result of the difference in diameter between the second step 63 and the third step 67 of the bearing pin 53. There is therefore a certain amount of friction against the shoulder 81 and against the locking ring 77 of the fourth roller bearing 25, which is in effect the bearing friction of the fourth roller bearing 25. To minimize this bearing friction, the contact surface between the rollers 79 and the locking ring 77 and/or the shoulder 81 of the bearing pin 53 as well as the relative movement of the rollers in the circumferential direction can be minimized.

FIGS. 3b, 3c, 3d, and 3e show four different embodiments of rollers 79. The roller 79 shown in FIG. 3b corresponds to the normal design, as shown in FIG. 3a. The roller 79 according to the diagram in FIG. 3b has flat ends 83. The roller 79 according to the diagram in FIG. 3c has a crowning 85 at both ends. Corresponding to the crowning 85, therefore, the contact surfaces with the shoulder 81 and with the locking ring 77 are minimized. The friction surface area can also be reduced by tapering 87, as shown in FIG. 3d. As a result of the tapering 87, the friction surface is reduced in each case to the tip 89 of the tapering 87. As can be seen in FIG. 3e, the roller 79 can also have an elevation 91 at each end. The elevation 91, as shown in FIG. 3e, also has a tip 89, which, when in contact with the locking ring 77 and the shoulder 81, can also have the effect of reducing the friction values. The elevation 91, as shown in FIG. 3e, can have any desired shape, such as a crowned or convex shape.

FIG. 4 shows another longitudinal cross section through the pivot axis 43 of an additional space-saving exemplary embodiment of the fourth roller bearing 25 of the joint arrangement 1. In contrast to the roller bearings 25 shown in FIGS. 2 and 3a, the fourth roller bearing 25 according to FIG. 4 does not have any bearing rings at all. The rolling elements 49, especially the rollers 79, of the fourth roller bearing 25 are therefore located directly between the bore 71 of the first lever 27 and the third step 67 of the bearing pin 53 and rest against these components. In the case of the fourth roller bearing 25 according to FIG. 4, therefore, two parts, namely, the inner bearing ring and the outer bearing ring, are eliminated. For this purpose it is necessary only to execute the bore 71 in the first lever 27 and the third step 67 of the bearing pin 53 with a quality suitable for roller bearings, namely, with a suitable surface quality, roundness, hardness, etc.

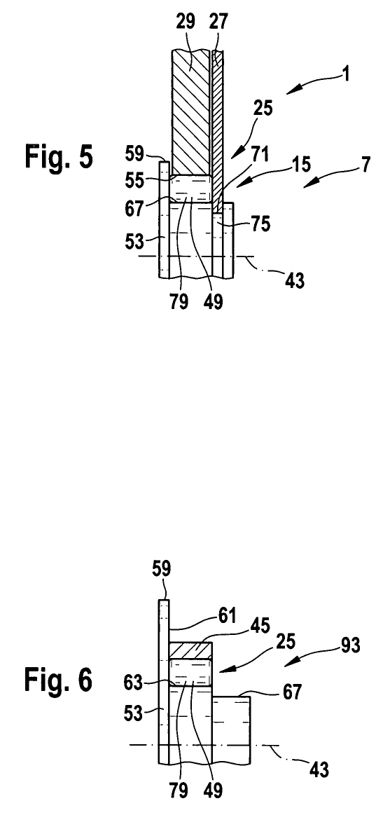

FIG. 5 shows another longitudinal cross section through the pivot axis 43 of another especially simple exemplary embodiment of the fourth roller bearing 25 of the joint arrangement 1. In contrast to the roller bearing shown in FIG. 4, the fourth roller bearing 25 according to FIG. 5 does not have a press-fit 57 between the bore 55 of the second lever 29 and the bearing pin 53. Instead, the bearing pin 53 according to the diagram in FIG. 5 has only the first step 59 and the third step 67. The third step 67 and the bore 55 of the second lever 29 serve as guide surfaces for the rolling elements 49 of the fourth roller bearing 25 according to the diagram in FIG. 5. The rolling elements 49 therefore rest against the third step and the bore 55. In this exemplary embodiment, therefore, the second lever 29 is supported pivotably on the bearing pin 53. Another difference is that the first lever 27 is permanently connected to the bearing pin 53. For this purpose, the first lever 27 can be permanently connected to the circumferential groove 75 of the third step 67 of the bearing pin 53. This permanent connection can be accomplished by, for example, riveting the first lever 27 to the bearing pin 53. Other connecting or joining techniques such as screwing, adhesive bonding, etc., could also be used.

FIG. 6 shows a longitudinal cross section through a pivot axis 43 of an assembly 93 for a joint arrangement 1 as described, for example, in FIGS. 1-5. The assembly 93 has a roller bearing 25 with an outer bearing ring 45. Rolling elements 49, e.g., rollers 79, are guided between a second step 63 of a bearing pin 53 and the bearing ring 45. To put the assembly 93 together, the rolling elements 49 and the bearing ring 45 can be pushed onto the second step 63 of the bearing pin 53. It is advantageous here for the bearing pin 53 to have a stop 61, which is formed by the difference in diameter between the first step 59 and the second step 63. The stop 61 thus makes it very easy to put the assembly 93 together.

The assembly 93 can be easily connected to a lever such as a lever similar to the second lever 29, by means of, for example, a press-fit between the outer bearing ring 45 and the bore 55 of the second lever 29. The connection with another lever, such as a lever similar to the first lever 27, can be accomplished in a manner similar to the riveting shown in FIG. 5 or possibly by means of a press-fit. A locking ring can also be provided as a guide for the rolling elements 49, which can be designed in different ways as already described above.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A multi-joint hinge for a motor vehicle having a body and a panel, the hinge allowing the panel to be moved between an open position and a closed position relative to the vehicle body, the hinge comprising at least one joint having a roller bearing.

2. The multi-joint hinge of claim 1 wherein the roller bearing comprises rolling elements, the rolling elements being at least one of balls, cylindrical rollers, needles, conical rollers, barrel rollers, convex rollers, rollers having ends with elevations, rollers having tapered ends, and rollers having ends with tips.

3. The multi-joint hinge of claim 2 wherein the roller bearing further comprises at least one of an inner bearing ring and an outer bearing ring for guiding the rolling elements.

4. The multi-joint hinge of claim 2 further comprising a bearing pin received through the roller bearing.

5. The multi-joint hinge of claim 4 further comprising a first lever and a second lever which are pivotable with respect to each other by means of the roller bearing.

6. The multi-joint hinge of claim 5 wherein the first lever has a first bore and the second lever has a second bore.

7. The multi-joint hinge of claim 6 wherein the bearing pin is received in the first bore in an interference fit.

8. The multi-joint hinge of claim 7 further comprising an outer bearing ring for guiding the rolling elements, the outer bearing ring being received in the second bore in an interference fit.

9. The multi-joint hinge of claim 8 further comprising an inner bearing ring for guiding the roller elements, the bearing pin being received in the inner bearing ring in an interference fit.

10. The multi-joint hinge of claim 4 wherein the bearing comprises an outer bearing ring, wherein the rolling elements are guided between the outer bearing ring and the bearing pin.

11. The multi-joint hinge of claim 6 wherein the rolling elements are guided between the first bore and the bearing pin.

12. The multi-joint hinge of claim 5 wherein the second lever is riveted to the bearing pin.

13. The multi-joint hinge of claim 1 wherein the hinge comprises a four-bar joint.

14. The multi-joint hinge of claim 13 wherein the four-bar joint comprises four roller bearings.

15. The multi-joint hinge of claim 14 wherein two of the bearings are mounted on the panel and two of the bearings are mounted on the vehicle.

16. The multi-joint hinge of claim 1 further comprising a source of energy to assist opening the panel.

17. The multi-joint hinge of claim 16 wherein the source of energy is a gas spring.

18. The multi-joint hinge of claim 16 wherein the source of energy is mounted to the vehicle body and the panel by pivot bearings.

19. A motor vehicle comprising:
a vehicle body;
a panel which can be pivoted between an open position and a closed position relative to the vehicle body; and
a multi-joint hinge fixed to panel and the vehicle body, the multi-joint hinge comprising at least one roller bearing.
